(19) United States
(12) Patent Application Publication
(10) Pub. No.: US 2008/0012525 A1
(43) Pub. Date: Jan. 17, 2008

(54) Insulation type battery charging structure/chargeable battery

(76) Inventors: Jung-Tsung Lin, Taipei Hsien (TW); Ding-kan Chang, Taipei City (TW)

Correspondence Address: BACON & THOMAS, PLLC, 625 SLATERS LANE, FOURTH FLOOR, ALEXANDRIA, VA, 22314, US

(21) Appl. No.: 11/487,397

(22) Filed: Jul. 17, 2006

(51) Int. Cl. H02J 7/00

(52) U.S. Cl. 320/107

(57) ABSTRACT

An insulation type electric charging structure/chargeable battery, wherein a receiving circuitry is provided in a chargeable battery having a power storage member, the receiving circuitry further has a receiving coil; when the receiving coil receives an alternative signal from outside in a non-contacting insulated mode, it changes the signal into electric power to do electric charging for the power storage member, thereby the battery does charging without conducting by contacting electrodes. Thus the electric charging needs no clamping connecting to or abutting on the electrodes of the battery; and chargeable batteries of which the sizes and lengths are different can be charged with the same seat; and in the non-contacting insulated charging mode, the battery can be charged without detaching and removing when it is fixed in an electric appliance.

### BACKGROUND OF THE INVENTION

1. Field of the Invention

The present invention relates to a technique of battery charging, and especially to a non-contacting insulation type chargeable battery charging in a mode without conducting by contacting electrodes. By virtue that in operation of electric charging of the chargeable battery of the present invention, there is no need of performing conducting of electrodes of the chargeable battery, a seat in cooperating with the chargeable battery has no limitation given by the positions of the electrodes in space and modeling to be used, this further makes the chargeable battery able to be directly provided and hidden in an electric product to do non-contacting insulation type charging.

2. Description of the Prior Art

Using of a chargeable battery is quite popular, for instance: general consumptive electronic products often use standard batteries, digital camera chargeable batteries, mobile phone chargeable batteries and walkman chargeable batteries etc.

As shown in FIGS. 1 and 2, the electric charging mode in the prior art is to place conventional chargeable batteries 91 in a conventional electric charging seat 92, positive electrode contacting pins 921 and negative electrode contacting pins 922 of the conventional electric charging seat 92 are respectively contacted with the positive electrodes 911 and the negative electrodes 912.

By virtue that the kinds and specifications of the chargeable batteries 91 are various, the distances and positions of the positive electrodes from/and the negative electrodes of all the specifications of the batteries 91 are different, e.g., the cylindrical chargeable batteries often used on general electronic products have different distances between the positive electrodes and the negative electrodes because of different specifications of the chargeable batteries, the positive electrodes and the negative electrodes of 9V chargeable batteries are arranged parallelly, while the positive electrodes and the negative electrodes of mobile phones are arranged in a specific mode etc. Thereby using of the conventional electric charging seat 92 shall comply with designs of the distances, orientations and modes of arrangements between/of the positive electrodes and the negative electrodes; various related specifications are used to mate with various conventional chargeable batteries 91 for contacting mode electric charging.

### SUMMARY OF THE INVENTION

### Technical Problems to be Solved

By virtue that performing of electric charging of conventional chargeable batteries is restrained by the distances and positions between/of positive electrodes and negative electrodes, and conventional electric charging seats often have the situation of male contact by elastic fatigue of the contact pins on positive electrodes and contact pins on negative electrodes. In view of this, an electric charging structure for storage of electric power in a non-contacting insulated mode has been designed, and such device is the main subject of the present invention.

### The Technical Measure for Solving the Problem

In order to make a chargeable battery able to store electric power in a non-contacting insulated mode, the structure of the present invention comprises: an emitting circuitry provided in a seat connecting externally to a power supply, the emitting circuitry is further provided with an emitting coil to emit an alternative signal through the emitting coil; a receiving circuitry provided in an electric chargeable battery having an electric power storage member, the receiving circuitry is further provided with a receiving coil; when the receiving coil gets close to the emitting coil, the receiving coil receives the alternative signal emitted from the emitting coil, then the receiving circuitry changes it into electric power to make an electric charging circuit do electric charging for the electric power storage member.

The emitting circuitry of the present invention further comprises a voltage-controlling frequency oscillating circuit, a driving circuit connected with the voltage-controlling frequency oscillating circuit, an emitting harmonic-oscillation circuit connected with the driving circuit, the abovementioned emitting coil is an extending means out of the emitting harmonic-oscillation circuit.

And the receiving circuitry further comprises a receiving harmonic-oscillation circuit, a rectifying wave filtering circuit connected with the receiving harmonic-oscillation circuit, an electric charging circuit connected with the rectifying wave filtering circuit, the electric charging circuit is used to charge the electric power storage member; the abovementioned receiving coil is an extending means out of the receiving harmonic-oscillation circuit.

The emitting circuitry further comprises therein a feedback circuit connected with the emitting harmonic-oscillation circuit, a first control circuit connected with the feedback circuit, the first control circuit is connected with the voltage-controlling frequency oscillating circuit, the feedback circuit feeds the alternative signal emitted from the emitting coil back to the first control circuit, the first control circuit makes comparison and analysis on the signal and inputs it into the voltage-controlling frequency oscillating circuit to thereby make optimization of the quality of harmonic oscillation generated by the emitting harmonic-oscillation circuit.

And more, the battery can be provided therein with a magnetism insulating layer, the magnetism insulating layer cuts off the magnetic path between the electric power storage member and the receiving coil; certainly, if plastic electric power storage members can be mass produced in the future, the magnetism insulating layer can be saved.

Moreover, the emitting coil and the receiving coil of the present invention can be provided in the mode of helical winding or planar winding with a slight distance from each other, they can both be used for conventional cylindrical alkali batteries and specific lithium batteries in the shapes of planar blocks for portable digital devices, the range of application of them is not limited.

### The Effect in Contrast to the Prior Art

By the technical measure of the present invention, during the electric charging process of the electric charging structure, the electrodes of a chargeable battery need not to be clamping connected or abutted on, designing of the seat will not be restrained by the distances, positions and orientations between/of positive electrodes and negative electrodes, and the chargeable battery can be fixed in an electric appliance, and can be charged in a non-contacting insulated mode, no action of detaching and removing is needed for the electric charging process.

The present invention will be apparent after reading the detailed description of the preferred embodiment thereof in reference to the accompanying drawings.

### BRIEF DESCRIPTION OF THE DRAWINGS

FIG. 1 is a schematic perspective view of a plurality of conventional chargeable batteries;

FIG. 2 is another schematic perspective view showing a conventional chargeable battery;

FIG. 3 is a schematic view showing the structure of a preferred embodiment of the present invention;

FIG. 4 shows circuit connecting of the preferred embodiment of the present invention;

FIG. 5 shows another preferred embodiment of the present invention;

FIG. 6 shows another preferred embodiment of the present invention;

FIG. 7 shows a further preferred embodiment of the present invention.

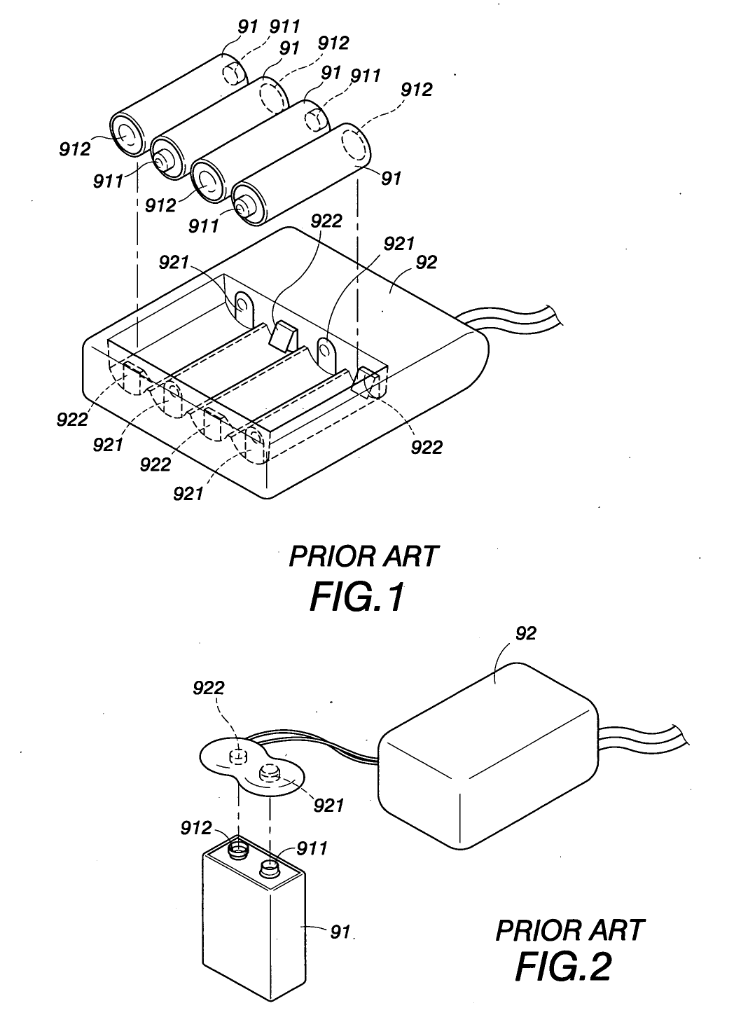

### DETAILED DESCRIPTION OF THE PREFERRED EMBODIMENT

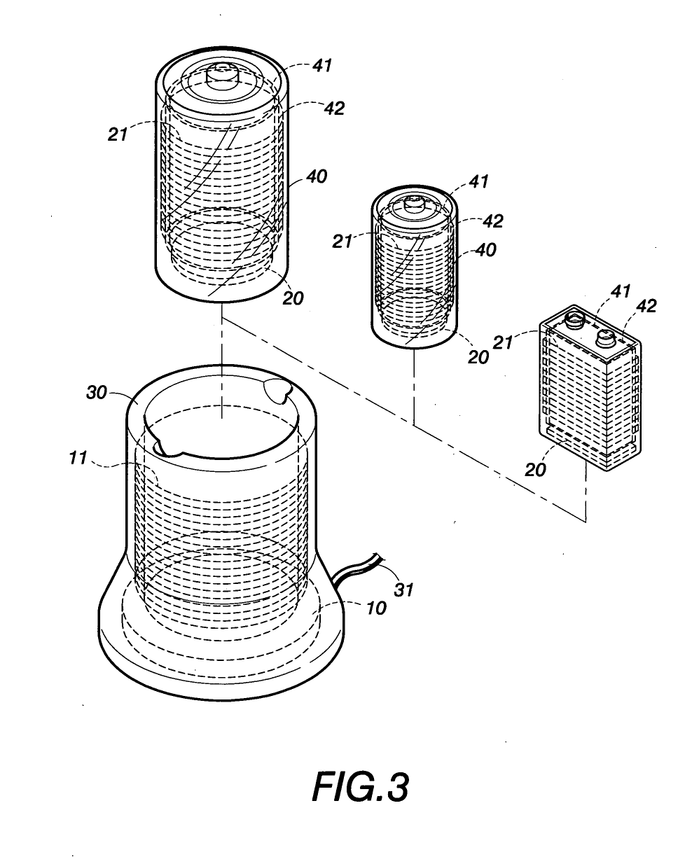

As shown in FIG. 3, the electric charging structure of the present invention comprises: an emitting circuitry 10 and a receiving circuitry 20, wherein the emitting circuitry 10 is provided in a seat 30 connecting externally to a power supply 31 to afford operation of the emitting circuitry 10, the emitting circuitry 10 is further provided with an emitting coil 11; the receiving circuitry 20 is provided in a smaller cylindrical chargeable battery, a larger cylindrical chargeable battery or a rectangular chargeable battery (shown in FIG. 3 all labeled with 40) or a chargeable battery of any of other shapes, for the purpose of electric charging the electric power storage member 41 provided in the electric chargeable battery 40.

The emitting circuitry 10 emits an alternative signal through the emitting coil 11, when the receiving coil 21 gets close to the emitting coil 11, the receiving coil 21 receives the alternative signal emitted from the emitting coil 11, then the receiving circuitry 20 changes it into electric power to do electric charging for the electric power storage member 41.

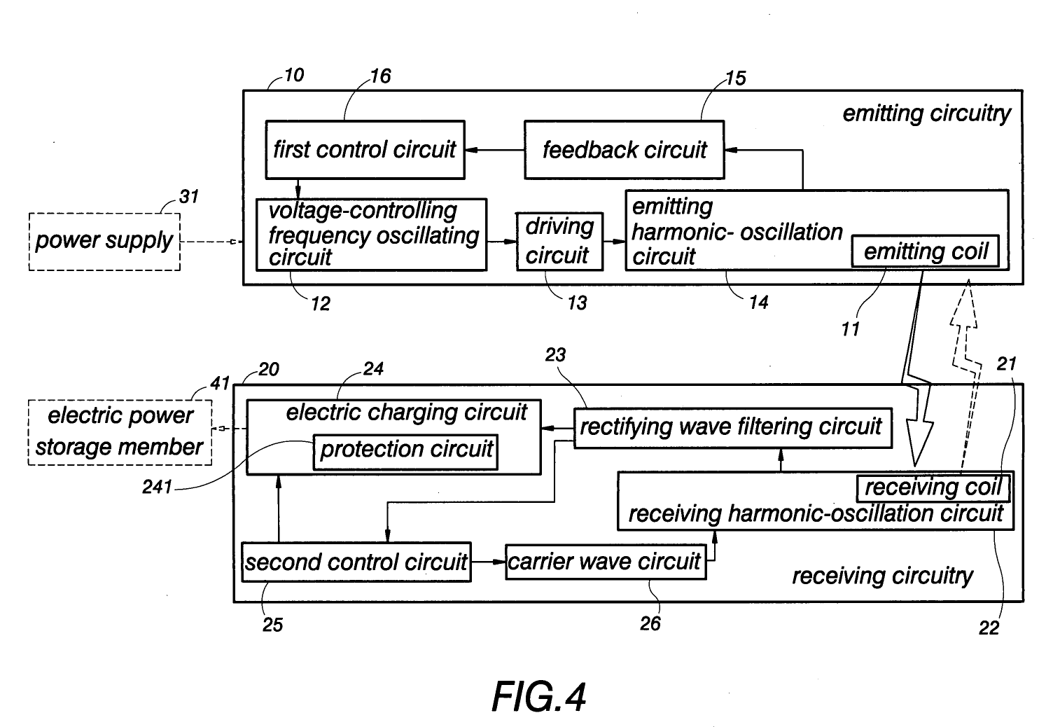

As shown in FIG. 4, the emitting circuitry 10 further comprises a voltage-controlling frequency oscillating circuit 12, a driving circuit 13 connected with the voltage-controlling frequency oscillating circuit 12, an emitting harmonic-oscillation circuit 14 connected with the driving circuit 13; the abovementioned emitting coil 11 is an extending means out of the emitting harmonic-oscillation circuit 14.

And the receiving circuitry 20 further comprises a receiving coil 21, a receiving harmonic-oscillation circuit 22, a rectifying wave filtering circuit 23 connected with the receiving harmonic-oscillation circuit 22, and comprises the electric charging circuit 24 connected with the rectifying wave filtering circuit 23, the electric charging circuit 24 is connected with the electric power storage member 41; the abovementioned receiving coil 21 is an extending means out of the receiving harmonic-oscillation circuit 22. In order to prevent the situations of overly discharging, overly charging or having overly low voltage for charging during the process that the receiving circuitry 20 charges the electric power storage member 41. The electric charging circuit 24 can be provided therein with a protection circuit 241, in order that using of the electric charging structure of the present invention is more stable.

The emitting circuitry 10 further comprises therein a feedback circuit 15 connected with the emitting harmonic-oscillation circuit 14, a first control circuit 16 connected with the feedback circuit 15, the first control circuit 16 is connected with the voltage-controlling frequency oscillating circuit 12.

With the abovementioned embodiment, the power supply 31 provides electric power for the emitting circuitry 10, the voltage-controlling frequency oscillating circuit 12 generates an alternative signal to be amplified by the driving circuit 13; then the amplified alternative signal gets harmonic oscillation through the emitting harmonic-oscillation circuit 14, and is emitted through the emitting coil 11. When the receiving coil 21 gets close to the emitting coil 11, it receives the alternative signal, by allocation of the receiving harmonic-oscillation circuit 22 and the rectifying wave filtering circuit 23, the amplified alternative signal is changed into electric power to make the electric charging circuit 24 do electric charging for the electric power storage member 41.

Meantime, the feedback circuit 15 feeds the alternative signal emitted from the emitting coil 11 back to the first control circuit 16 (containing therein a micro-processor), the first control circuit 16 makes comparison and analysis on the signal and inputs it into the voltage-controlling frequency oscillating circuit 12 to thereby make optimization of the quality of harmonic oscillation generated by the emitting harmonic-oscillation circuit 14.

When in practicing, by the fact that the main ingredient of the electric power storage member 41 still is metal, when the receiving coil 21 receives the alternative signal, the electric power storage member 41 made of metal may create a magnetic path to influence the alternative signal, so that the present invention can be provided between the electric power storage member 41 and the receiving coil 21 with a magnetism insulating layer 42 to cut off the metallic magnetic path; surely, if plastic electric power storage members 41 can be mass produced in the future, the magnetism insulating layer 42 can be saved.

And more, by virtue that the present invention needs no connection to the exposed positive and negative electrodes of the electric chargeable battery 40 in practicing, designing of the seat 30 will not be restrained by the factors of specification including the distances, positions and orientations between/of the electrodes of the chargeable battery 40; and the same seat 30 can be used for chargeable batteries of different sizes and lengths.

Besides, the receiving circuitry 20 can further comprise a second control circuit 25 and a carrier wave circuit 26 for data transmission with the emitting circuitry 10, so that the receiving circuitry 20 and the emitting circuitry 10 can do data transmission.

And the emitting circuitry 10 as well as the receiving circuitry 20 can be presented as integrated circuits (IC) in order that the spaces occupied by the emitting circuitry 10 and the receiving circuitry 20 can be even smaller.

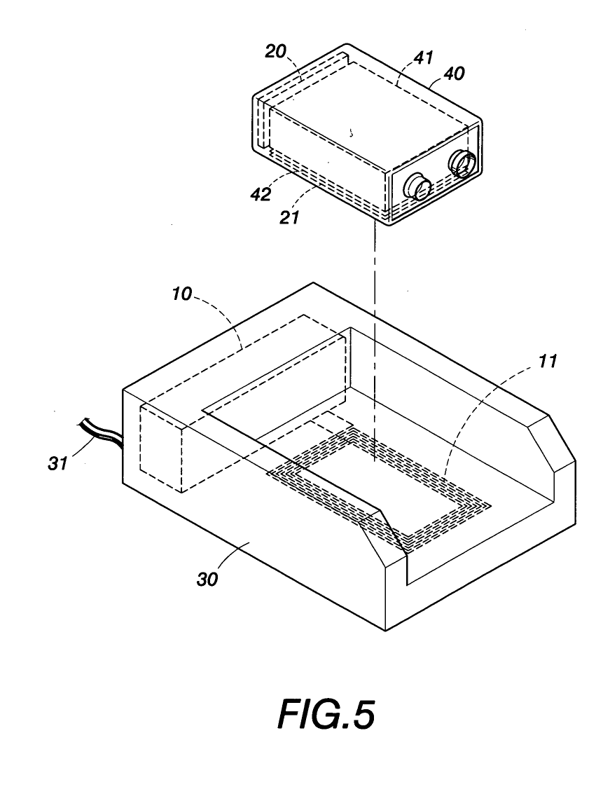

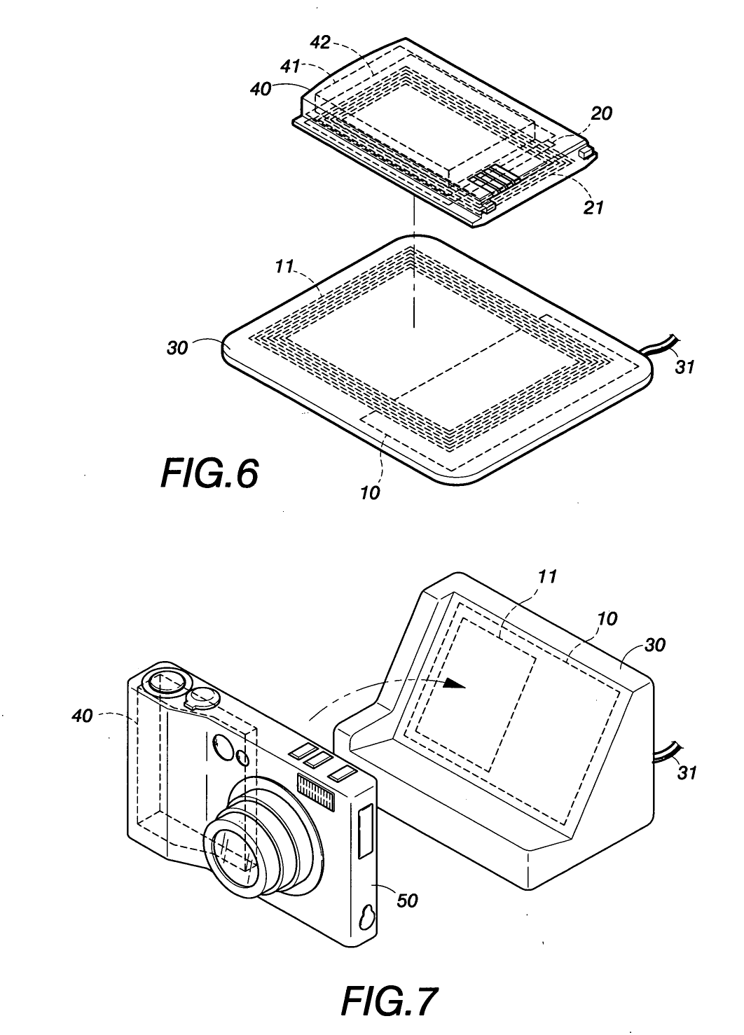

As shown in FIGS. 5 and 6, in addition to the mode of helical winding, the emitting coil 11 and the receiving coil 21 can be provided in the mode of planar winding, thereby the electric charging structure of the present invention can be applied on various electric chargeable batteries 40 such as a rectangular chargeable battery, a chargeable battery for a mobile phone, a chargeable battery for a digital camera and a chargeable battery for a palm computer etc., or specific batteries for other electric products.

As shown in FIG. 7, by virtue that the electric charging structure of the present invention can do electric charging without electrode connecting for conducting, an electric chargeable battery 40 can directly be provided and hidden in an electric product (such as in a camera, a mobile phone, a notebook, a palm computer, a walkman, an electronic dictionary or other electric products convenient for being electrically charged for use); when the electric chargeable battery 40 is short of electric power and needs electric charging, it needs only to have the electric appliance placed near the seat 30, and non-contacting insulation type charging can be done.

Further, in practicing the present invention, because that manufacturing of a chargeable battery and an electric charging seat are different articles that are made by different manufacturing processes, this is true especially for an MP3 PLAYER and a small digital camera etc., the chargeable battery of the present invention may be directly built in a device only with the necessity of matching with a suitable electric charging seat. Therefore, the chargeable battery of the present invention can be independently manufactured; i.e., as is stated above, the electric chargeable batteries 40 is provided therein with the receiving circuitry 20 which further has the receiving coil 21, the receiving coil 21 receives the alternative signal from outside, and changes it into electric power to do electric charging for the electric power storage member 41; the electric chargeable batteries 40 needs not to do electric charging in the mode of conducting by contacting electrodes.

The alternative signal from outside is emitted from the emitting circuitry 10 that is provided in the seat 30, the elements of combination and the principle of operating of the emitting circuitry 10 is just that stated above, and no further narration is needed.

The embodiment given is only for illustrating the present invention, and not for giving any limitation to the scope of the present invention; it will be apparent to those skilled in this art that various modifications or changes without departing from the spirit of this invention shall also fall within the scope of the appended claims.

1. An insulation type electric charging structure comprising:
an emitting circuitry provided in a seat connecting externally to a power supply, said emitting circuitry is further provided with an emitting coil to emit an alternative signal through said emitting coil; and
a receiving circuitry provided in an electric chargeable battery having an electric power storage member, said receiving circuitry is connected with said electric power storage member and is further provided with a receiving coil; when said receiving coil gets close to said emitting coil, said receiving coil receives said alternative signal emitted from said emitting coil, then said receiving circuitry changes it into electric power to do electric charging for said electric power storage member; thereby said electric chargeable battery and said seat need not to do electric charging in the mode of conducting by contacting electrodes.

2. The insulation type electric charging structure as in claim 1, wherein: said emitting circuitry further comprises a voltage-controlling frequency oscillating circuit, a driving circuit connected with said voltage-controlling frequency oscillating circuit, an emitting harmonic-oscillation circuit connected with said driving circuit, said emitting coil is an extending means out of said emitting harmonic-oscillation circuit; said receiving circuitry further comprises a receiving harmonic-oscillation circuit, a rectifying wave filtering circuit connected with said receiving harmonic-oscillation circuit, an electric charging circuit connected with said rectifying wave filtering circuit, said electric charging circuit is used to charge said electric power storage member; said receiving coil is an extending means out of said receiving harmonic-oscillation circuit.

3. The insulation type electric charging structure as in claim 2, wherein: said emitting circuitry further comprises a feedback circuit connected with said emitting harmonic-oscillation circuit, a first control circuit connected with said feedback circuit, said first control circuit is connected with said voltage-controlling frequency oscillating circuit; said feedback circuit feeds said alternative signal emitted from said emitting coil back to said first control circuit, said first control circuit makes comparison and analysis on said signal and inputs it into said voltage-controlling frequency oscillating circuit to thereby make optimization of quality of harmonic oscillation generated by said emitting harmonic-oscillation circuit.

4. The insulation type electric charging structure as in claim 1, wherein: said battery is provided therein with a magnetism insulating layer, said magnetism insulating layer cuts off a magnetic path between said electric power storage member and said receiving coil.

5. The insulation type electric charging structure as in claim 1, wherein: said chargeable battery is fixed in an electronic product, said electronic product is directly placed near said seat when in electric charging in order that said receiving coil receives said alternative signal emitted from said emitting coil.

6. An insulation type chargeable battery, wherein: a receiving circuitry is provided in said electric chargeable battery which belongs to a electric power storage member, said receiving circuitry is further provided with a receiving coil and an electric charging circuit; when said receiving coil receives an alternative signal from outside in a non-contacting insulated mode, it changes said signal into electric power to do electric charging for said electric power storage member, thereby, said chargeable battery does electric charging without conducting by contacting electrodes.

7. The insulation type chargeable battery as in claim 6, wherein: said receiving circuitry is presented as an integrated circuit.

8. The insulation type chargeable battery as in claim 6, wherein: said electric charging circuit includes a protection circuit.

9. The insulation type chargeable battery as in claim 6, wherein: said alternative signal is emitted from said emitting circuitry that is provided in a seat connecting externally to a power supply, said emitting circuitry is further provided with an emitting coil to emit an alternative signal through said emitting coil.

10. The insulation type chargeable battery as in claim 9, wherein: said receiving circuitry further comprises a second control circuit and a carrier wave circuit for data transmission with said emitting circuitry.

11. The insulation type chargeable battery as in claim 9, wherein: said emitting circuitry further comprises a voltage-controlling frequency oscillating circuit, a driving circuit connected with said voltage-controlling frequency oscillating circuit, an emitting harmonic-oscillation circuit connected with said driving circuit, said emitting coil is an extending means out of said emitting harmonic-oscillation circuit; said receiving circuitry further comprises a receiving harmonic-oscillation circuit, a rectifying wave filtering circuit connected with said receiving harmonic-oscillation circuit, an electric charging circuit connected with said rectifying wave filtering circuit, said electric charging circuit is used to charge said electric power storage member; said receiving coil is an extending means out of said receiving harmonic-oscillation circuit.

12. The insulation type chargeable battery as in claim 9, wherein: said emitting circuitry is presented as an integrated circuit.

13. The insulation type chargeable battery as in claim 9, wherein: said emitting coil and said receiving coil are provided in the mode of helical winding with a slight distance from each other.

14. The insulation type chargeable battery as in claim 13, wherein: said electric power storage member and said receiving coil are provided therebetween with a magnetism insulating layer to cut off a metallic magnetic path.

15. The insulation type chargeable battery as in claim 9, wherein: said emitting coil and said receiving coil are provided in the mode of planar winding with a slight distance from each other.

16. The insulation type chargeable battery as in claim 9, wherein: said chargeable battery is fixed in an electronic product, said electronic product is directly placed near said seat when in electric charging in order that said receiving coil receives said alternative signal emitted from said emitting coil.
